(19) United States
(12) Patent Application Publication
(10) Pub. No.: US 2013/0194431 A1
(43) Pub. Date: Aug. 1, 2013

(54) AUTOMATED BROADCAST SYSTEMS AND METHODS

(71) Applicant: CONCERT WINDOW, LLC, Cambridge, MA (US)

(72) Inventors: Elijah Forrest O'Connor, Cambridge, MA (US); Daniel Patrick Gurney, Cambridge, MA (US)

(73) Assignee: CONCERT WINDOW, LLC, Cambridge, MA (US)

(21) Appl. No.: 13/764,367

(22) Filed: Feb. 11, 2013

Related U.S. Application Data
(63) Continuation of application No. 13/360,635, filed on Jan. 27, 2012.

(51) Int. Cl. H04N 7/18

(52) U.S. Cl. CPC H04N 7/18
USPC 348/159

(57) ABSTRACT

Automated broadcast from one or more physical venue locations is described. One system includes multiple automated broadcast sets, disposed on location at the physical venue locations, and one or more content delivery network servers. An automated broadcast set, disposed at each location of the physical venue locations, comprises a plurality of cameras, one or more optional microphones, and at least one router or a local computer. The cameras are pre-positioned at different sight angles within the corresponding physical venue location and are configured to automatically capture images. The optional microphones are pre-positioned at the corresponding physical venue location and automatically capture audio. The router or the local computer is configured to encode and transmit received video and audio signals over a network.

### CROSS-REFERENCE TO RELATED APPLICATION(S)

This application is a continuation of and claims benefit of U.S. patent application Ser. No. 13/360,635 entitled “AUTOMATED BROADCAST SYSTEMS AND METHODS,” (Attorney Docket No. 78202-8001.US01), which was filed on Jan. 27, 2012, the contents of which are all incorporated by reference herein.

### FIELD OF THE INVENTION

At least one embodiment of the present invention pertains to media distribution, and more particularly, to systems and methods for recording, managing, and distributing images and/or other content from live events generated from multiple cameras or sensors disposed on location at each of a plurality of physical venue locations.

### BACKGROUND

Live performances have been very popular for many years. Each year, hundreds of millions audiences attend live performances at a variety of venues, such as stadiums, auditorium halls, parks, bars etc. Audiences find live performances attractive. Unlike performances recorded in a studio, live performances involve exchanges between performers and their audiences. For example, performers often interject comments between episodes and audiences often react to such comments with applauses, cheering, etc..

The explosive growth of technologies and the Internet has made it possible for audiences to experience live performances on TVs or computers at home. Live performances may be broadcast through a single personal computer (PC) camera from one Internet user to other users. However, the quality of such single camera broadcasting is normally not good. Performers are limited to a small area in front of the single PC camera. In addition, an operator is required to control the PC camera. On the other hand, if a high quality video broadcast is desired, such broadcast typically requires professional video cameras on pedestals, one or more camera operators, stage lighting rigs and the associated control equipment, etc. This type of video broadcasting is not only expensive but also intrusive for small venues.

In consequence, the present inventor has recognized that there is value in having a high quality automated broadcast system, including non-intrusive cameras. The present inventor has identified a need to automatically broadcast live performances with high image quality at a variety of physical venues and provide network users an option to search and watch such live performances over the Internet.

### SUMMARY

The present disclosure provides a variety of teachings for an automated broadcast system. One automated broadcast system includes a plurality of automated broadcast sets and a content delivery network server. An automated broadcast set may be disposed on location at each of a plurality of physical venue locations. Each physical venue location is configured to host live events. The present disclosure is not limited to an automated broadcast system operable at multiple physical venue locations. Those skilled in the art will appreciate that the principles of the present disclosure can be used in an automated broadcast system operable at a single physical venue location.

The automated broadcast set may comprise a plurality of cameras, and at least one router and/or a local computer. In some implementations, the automated broadcast set may further comprise one or more optional microphones. The plurality of cameras may be pre-positioned at different sight angles within the corresponding physical venue location and configured to automatically capture images from live events at the corresponding physical venue location. The one or more optional microphones may be pre-positioned at the corresponding physical venue location and configured to automatically capture audio from the live events. The at least one router or the local computer may have one or more IP address(es) and may be configured to receive video signals from the plurality of cameras and/or receive audio signals from the one or more optional microphones. The at least one router or the local computer may be configured to encode and transmit received audio signals and video signals over a network. Other sensors, such as motion sensors, may be disposed on location for this information encoded for transmission.

The content delivery network server, coupled to the network, may be configured to receive and decode the encoded audio signals and video signals from each automated broadcast set. The content delivery network server may be further configured to receive requests from a plurality of network users for substantially real-time access to live events at the plurality of physical venue locations, and broadcast to the network users selected live events upon authorized payments or subscriptions. As will be appreciated by those skilled in the art, the content delivery network server may comprise multiple servers. In some implementations, one or more these multiple servers may be configured to receive and decode the encoded information of live events. In some implementations, one or more these multiple servers may be configured to receive requests from network users and broadcast selected live events in substantially real-time to subscribers or paid customers. In some implementations, these multiple servers may be located at the same physical location. In some implementations, these multiple servers may be located at multiple physical locations.

In one embodiment of the present disclosure, one or more computer program(s), stored on the content delivery network server, may be configured to allow server operator(s) or venue manager(s) to schedule automated capture of a live event at the corresponding physical venue location. The computer program(s) may comprise: instructions to turn on the plurality of cameras and/or the one or more optional microphones at the corresponding physical venue location at the beginning of a scheduled time period, wherein the scheduled time period may be preset by server operator(s) and/or venue operator(s); instructions to transmit the audio signals from the one or more optional microphones to the at least one router and/or the local computer; instructions to transmit the video signals from the plurality of cameras to the at least one router and/or the local computer at the corresponding venue location according to a predetermined pattern, wherein the predetermined pattern may be preset by the server operator(s) and/or the venue operator(s); instructions to encode the video signals and the audio signals for transmission over the network; instructions to transmit encoded video signals and encoded audio signals to the content delivery network server over the network; instructions to receive encoded video and audio signals and decode received signals; and instructions to turn off the plurality of cameras and the one or more optional microphone(s) at the corresponding physical venue location of the live event at the end of the scheduled time period.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates a schematic block diagram of an automated broadcast system according to one embodiment(s) of the present disclosure.

FIG. 2 is a flow diagram of a process for automatically broadcasting live events on a network according to another embodiment(s) of the present disclosure.

FIG. 3 illustrates a schematic block diagram of a content delivery network server according to yet another embodiment(s) of the present disclosure.

FIG. 4 is a flow diagram of a process for automatically recording live events at a plurality of physical venues according to yet another embodiment(s) of the present disclosure.

### DETAILED DESCRIPTION

References in this specification to “an embodiment”, “one embodiment”, or the like, mean that the particular feature, structure or characteristic being described is included in at least one embodiment of the present disclosure. Occurrences of such phrases in this specification do not necessarily all refer to the same embodiment.

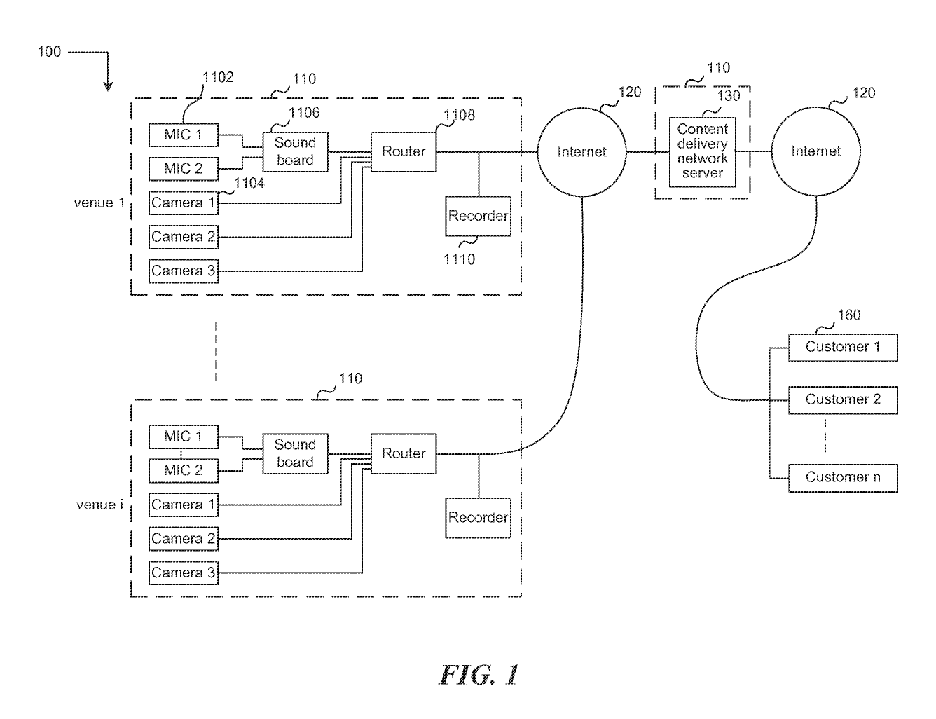

FIG. 1 illustrates a schematic block diagram of an automated broadcast system 100 according to one embodiment(s) of the present disclosure. The automated broadcast system 100 may include a plurality of automated broadcast sets 110 and a content delivery network server 130. An automated broadcast set 110 may be disposed on location at each of a plurality of physical venue locations. The plurality of physical venues may include, but not limited to, clubs, public houses, concert halls, outdoor bandstands, home venues etc. In some implementations, the automated broadcast set 110 may be disposed at its corresponding physical venue location through a lease. In some implementations, the automated broadcast set 110 may be owned by its corresponding physical venue. Each of the plurality of physical venue locations is configured to host live events. The automated broadcast set 110 may include a plurality of cameras 1104, and one or more routers 1108.

The plurality of cameras 1104 may be pre-positioned at different sight angles for live events at each physical venue location. The cameras 1104 may be installed at desired locations and adapted to each specific physical venue. In some implementations, the cameras 1104 may be installed non-intrusively to performers and audiences of live events at each specific physical venue. In some implementations, at least one camera of the plurality cameras 1104 may be configured to provide a wide master shot of the entire stage and capture overall live events at the corresponding physical venue location. In some implementations, one of the plurality cameras 1104 may be configured to provide close-up image(s) of leading performer(s) of live events at the corresponding physical venue location. In some implementations, the cameras 1104 may be professional high quality cameras.

The cameras 1104 are coupled to the router 1108 and/or a local computer via a wired or wireless communications mechanism in a manner well known in the art. For instance, the cameras 1104 may be connected to the router 1108 and/or the local computer via camera cables. In some implementations, the cameras 1104 may be coupled to the router 1108 and/or the local computer via a Wi-Fi mechanism. Wi-Fi allows electronic devices to exchange date wirelessly and connect to a network resource, such as the Internet, via a wireless network access point.

In some implementations, the cameras 1104 may be operable to generate 30 frames or more digital images per second and may be turned on and off automatically. The cameras 1104 may be programmed to automatically capture images from live events at the corresponding physical venue locations and transmit video signals according to a particular pattern. In some implementations, the particular pattern may include automatically switching between the cameras with different sight angles after a fixed period of time, such as every 30 seconds. In some implementations, the particular pattern may be an event specific pattern that may be preset by an operator of the server 130 and/or a manager of the corresponding physical venue location. In some implementations, the pan angles, the tilt angles, and the zoom ratios of the cameras 1104 may be programmed and automatically controlled.

In some implementations, the automated broadcast set 110 may further include one or more optional microphones 1102. The one or more optional microphones 1102 may be turned on and off automatically and configured to automatically capture audio from live events at the corresponding physical venue locations. The one or more optional microphones 1102 may be coupled to the router 1108 and/or the local computer via a wired or wireless communications mechanism in a manner well known in the art. For instance, the one or more optional microphone(s) 1102 may be connected to the router 1108 and/or the local computer via audio cables. In some implementations, the one or more optional microphones 1102 may be coupled to the router 1108 and/or the local computer via FM radio, infrared waves, or Wi-Fi mechanisms. In some implementations, the one or more optional microphone(s) 1102 may be connected to a sound mixer. The sound mixer may be coupled to a sound board 1106 that is coupled to the one or more router(s) 1108 and/or the local computer via a wired or wireless communications mechanism in a manner well known in the art. In some implementations, one optional microphone at a specific physical venue location may be pre-installed to capture audio of audience's response during live events at the specific venue location.

The one or more router(s) 1108 may have one or more Internet Protocol (IP) address(es). The IP address is associated with the location of the router(s) 1108 over the entire Internet. In some implementations, the automated broadcast set 110 may include a local computer. The local computer may have one or more IP addresses. The router(s) 1108 and/or the local computer are coupled to the plurality of cameras 1104 and/or the one or more optional microphones 1102 via cables and/or wireless connections at each physical venue location. In some implementations, the router(s) 1108 and/or the local computer may be configured to combine video signals from the cameras 1104 and audio signals from the optional microphone(s) 1102 and then encode and stream combined signals via the Internet 120. In some implementations, the router(s) 1108 and/or the local computer may be configured to further compress the combined video and audio signals before streaming them via the Internet 120.

In some implementations, the automated broadcast set 110 may include other optional sensors, such as motion sensors etc., disposed on location at the plurality of physical venue locations. The optional sensors are operable to control live image and audio recorded and/or transmitted from the plurality of physical venue locations. In some implementations, optional sensors are operable to turn on and/or turn off the plurality of cameras 1104 and the one or more optional microphones 1102 at the corresponding venue locations. In some implementations, optional sensors are operable to trigger the one or more router(s) 1108 and/or the local computer at the corresponding venue locations to transmit encoded video and/or audio signals over a network. Those of skill in the art will appreciate that these optional sensors are not limited to motion sensors. Other sensors, such as light sensors, vibration sensors, sound sensors, temperature sensors, etc., may be used to control live image and audio recorded and/or transmitted from the plurality of physical venue locations.

In some implementations, the automated broadcast set 110 may further include a recorder 1110. The recorder 1110 may be coupled to the plurality of cameras 1104, the one or more optional microphones 1102, and the router 1108. The recorder 1110 may be any medium device configured to store digital data, such as a hard drive, RAM, ROM, flash memory, CD-ROM, digital versatile disks (DVD), solid-state drive (SSD), or the like. The recorder may be configured to store video signals from the cameras 1104 and audio signals from optional microphone(s) 1102. In some implementations, the recorder may be configured to record video signals and audio signals at a specific physical venue location to facilitate an unexpected Internet breakdown and/or facilitate requests of broadcast delays.

The content delivery network server 130 is coupled to the Internet 120. In some implementations, the content delivery network server 130 may have one or more IP addresses. In some implementations, the content delivery network server 130 may comprise multiple content delivery network servers located at the same or multiple physical locations. The content delivery network server 130 may be configured to receive and decode live video and audio signals of a live event from the one or more router(s) 1108 and/or the local computer at the corresponding physical venue location. The content delivery network server 130 may be configured to encode live video and audio signals and stream them to customers via the Internet. In some implementations, the content delivery network server 130 may be configured to save video and audio signals of a specific live event and convert them to recordings. An option may be provided to an interested customer to purchase a copy of the recordings on the specific live event by paying a particular price.

In some implementations, the content delivery network server 130 may include a plurality of computer programs. The programs may be configured to allow an operator of the server 130 and/or venue managers to maintain a broadcast schedule of available live events at the plurality of physical venue locations. The schedule of available live events at each specific physical venue location may be created and/or modified by the server operator and/or a manager of the specific venue location. In some implementations, the programs may be configured to allow the server operator and/or the venue manager of a specific physical venue location to preset the broadcast schedule of a live event at the specific physical venue location, e.g. time, duration, etc. In some implementations, the programs may be configured to allow the server operator(s) and/or the venue manager(s) of a live event to preset a particular pattern that captured images are transmitted from the plurality of cameras to the router(s) 1108 and/or the local computer at the corresponding physical venue location. In some implementations, the programs may be configured to allow the server operator(s) and/or the venue manager(s) to preset the pan angle, the tilt angle, and the zoom ratio of a specific camera at the corresponding physical venue location. In some implementations, a local computer at a specific venue location may be configured to allow a manager of the specific venue location to create and modify the broadcast schedule of available live events at the specific physical venue location. In some implementations, the programs may be configured to track the popularity of each of said physical venue locations and the popularity of leading performers of said live events. In some implementations, the server 130 may be a cloud-based server.

In some implementations, the content delivery network server 130 may be configured to handle the communication with Internet users, process the incoming orders from Internet users, and maintain the billing data and orders of subscribers and pay-per-view customers. In some implementations, the content delivery network server 130 may be configured to allow an internet user watch selected live event(s) substantially in real-time by either paying subscription fees or paying pay-per-view fees. In some implementations, the content delivery network server 130 may be configured to provide a user menu for Internet users. The user menu may be associated with the broadcast schedule of available live events at the plurality of physical venue locations. The menu may be configured to allow a customer to view available live events, select interested live events, and order selected live event(s). In some implementations, the menu may be configured to allow the customer to modify and/or cancel the order by entering the order number. In some implementations, the server 130 may be configured to provide an option for a customer to set up his or her own personal account. The customer may log on his or her personal account to track, modify and/or cancel his or her order(s).

Those of skill of the art will recognize that the content delivery network server 130 may comprise a variety of servers. In some implementations, one or more of the variety of servers may be configured to receive and decode the encoded information of live events. One or more of the variety of servers may be configured to receive requests from network users and broadcast selected live events in substantially real-time to subscribers or paid customers. In some implementations, one or more of the variety of servers may be located at the same physical location. In some implementations, the variety of servers may be located at multiple physical locations.

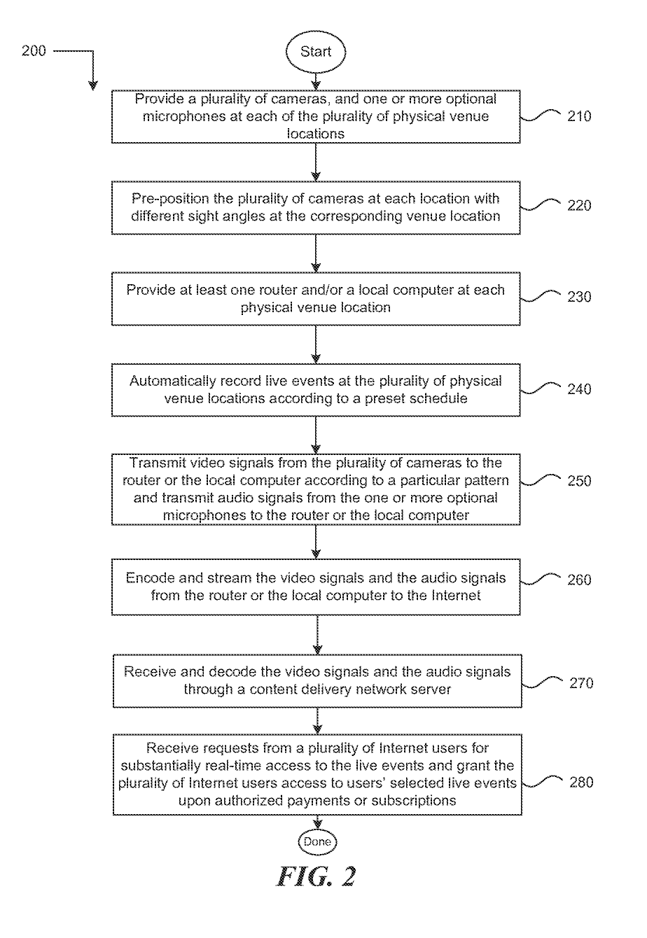

FIG. 2 illustrates a flow diagram of a process for automatically broadcasting live events on a network according to another embodiment(s) of the present disclosure. At step 210, a plurality of cameras 1104, and one or more optional microphones 1102 may be provided at each location of a plurality of physical venue locations. At step 220, the plurality of cameras 1104 at each physical venue location may be pre-positioned at different sight angles at the corresponding venue location. At least one camera of the plurality cameras 1104 may provide a shot of the entire stage and capture overall live events at each corresponding physical venue location. At least one router 1108 and/or a local computer are provided at each specific physical venue location, step 230. The at least one router 1108 or the local computer may have one or more IP address(es) and may be coupled to the plurality of cameras 1104 and one or more optional microphones 1102 via wired or wireless communications mechanisms in a manner well known in the art.

Live events at a specific physical venue location may be automatically recorded by the plurality of cameras 1104 and one or more optional microphones 1102 disposed at the specific venue location according to a preset schedule, step 240. The preset schedule may be created or modified by an operator of the content delivery network server 130 and/or a manager of the specific venue location. At the specific physical venue location, video signals may be transmitted from the plurality of cameras 1104 to the at least one router 1108 or the local computer according to a particular pattern while audio signals may be transmitted from the one or more optional microphones 1102 to the at least one router 1108 or the local computer, step 250. In some implementations, the video and audio signals may be combined and compressed by the at least one router 1108 or the local computer. In some implementations, the video and audio signals of the live event at the specific physical venue location may be encoded and streamed to a content delivery network server 130 through the at least one router 1108 or the local computer, step 260. Streamed video signals and audio signals may be received and decoded by the content delivery network server 130, 270. In some implementations, compressed video signals and audio signals are de-compressed by the content delivery network server 130.

In some implementations, a schedule of available live events at the plurality of physical venue locations 110 may be viewable to Internet users on the content delivery network server 130. The content delivery network server 130 may be configured to allow an internet user to select interest live event(s) from available live events and send the server a request to watch selected live event(s). At step 280, the request from the Internet user for access to the live event(s) is received at the content delivery network server 130 and access to the user selected live event(s) is granted upon authorized payment or subscription. In some implementations, a user menu associated with the schedule of available live events may be provided on the content delivery network server 130. The menu may be configured to allow a customer to modify or cancel his or her order by entering the order number. In some implementations, an option may be provided for a customer to set up his or her own personal account on the content delivery network server 130. The user may log on to his or her personal account to track, modify and/or cancel his or her prior order(s).

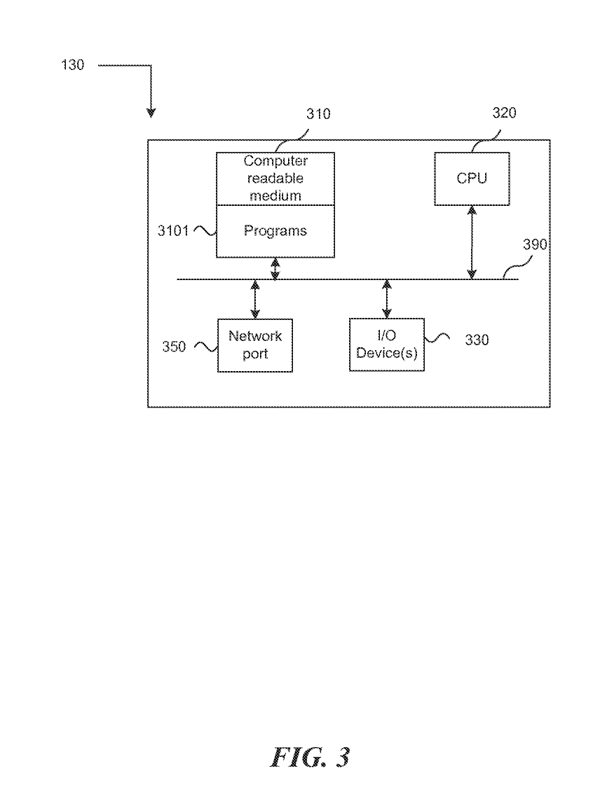

FIG. 3 illustrates a content delivery network server 130 according to yet another embodiment(s) of the present disclosure. The content delivery network server 130 may include at least a processor or a central processor unit (“CPU”) 320, one or more network port 350, one or more input/output (I/O) devices 330 such as a keyboard, touch screen or other touch input device, a display, speakers, printer etc., and one or more computer readable medium 310, all interconnected via one or more internal bus 390. The content delivery network server 130 preferably may include an operating system, such as but not limited to Windows™ Linux™, or Unix™. The computer readable medium 310 may be any medium device that is configured to store data, such as a hard drive, RAM, ROM, flash memory, electrically erasable program read-only memory (EEPROM), CD-ROM, digital versatile disks (DVD), or the like.

Programs 3101 are stored on the computer readable medium 310. The programs 3101 may be configured to allow an operator of the content delivery network server 130 or a manager of the specific venue location to create and/or modify a broadcast schedule of available live events at each specific physical venue location. The programs 3101 may be configured to allow the server operator and/or the venue manager to preset the time and duration of a live event at the specific physical venue location. In some implementations, the programs 3101 may be configured to allow the server operator or the venue manager to preset a particular pattern for the plurality of cameras at the specific physical venue location to transmit captured images to the router or the local computer at the corresponding venue location. In some implementations, the automated broadcast program may be configured to allow the server operator and/or the venue manager to preset the pan angles, the tilt angles, and the zoom ratios of a specific camera at the corresponding physical venue location.

The programs 3101 that reside in the computer readable medium 310 may be configured to handle the communication with Internet users, process the incoming orders from customers, and maintain customers' billing data and orders. The programs 3101 may be configured to provide a user menu, associated with available live events at the plurality of physical venue locations, for a customer to place an order of selected live event(s) and modify and/or cancel the order by entering the order number. In some implementations, the programs 3101 may be configured to provide an option for a customer to set up his or her own personal account and to log on his or her personal account to track, modify, and/or cancel his or her prior orders. In some implementations, the programs 3101 may be configured to allow a server operator and/or a manager of a specific physical venue location to post on the content delivery network server 130 promotion(s) of available live event(s) at the specific venue location.

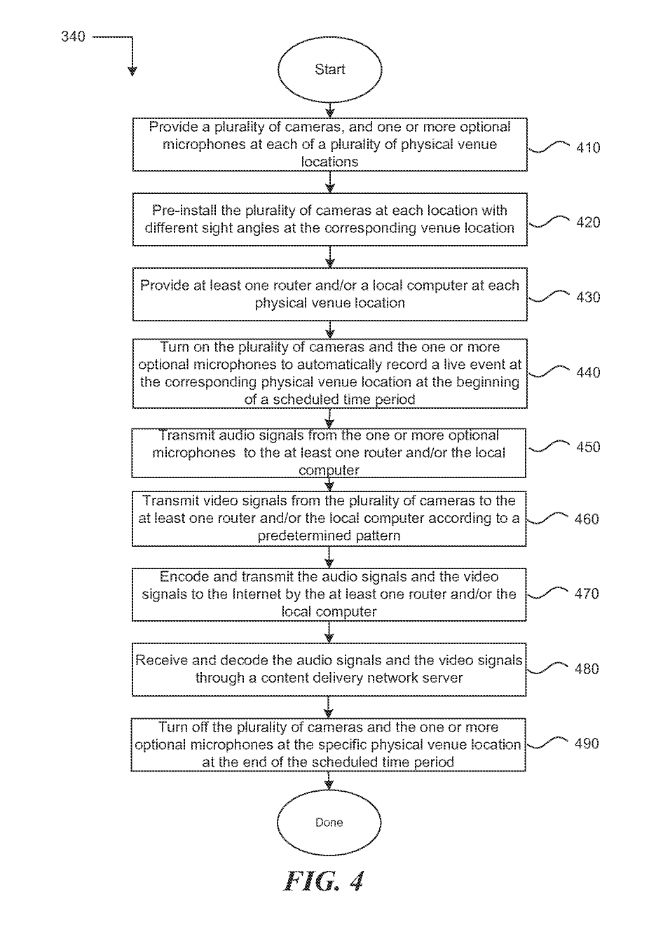

FIG. 4 illustrates a flow diagram of a process for automatically recording live events at a plurality of physical venues according to yet another embodiment(s) of the present disclosure. At step 410, a plurality of cameras, and one or more microphones may be provided at one location of a plurality of physical venue locations. At step 420, the plurality of cameras at a physical venue location may be pre-installed at different sight angles and adapted to the corresponding physical venue location. In some implementations, at least one cameras at one or more locations of the one or more physical venue locations may be configured to provide a shot of the entire stage and capture overall live events at the corresponding venue location. At step 430, at least one router and/or a local computer may be provided at each specific physical venue location. The at least one router or the local computer may have one or more IP addresses and may be coupled to the plurality of cameras and one or more optional microphones via wired or wireless communications mechanisms in a manner well known in the art.

At the beginning of a scheduled time period to automatically broadcast a live event, step 440, a plurality of cameras and one or more optional microphones at the corresponding physical venue location of the live event may be automatically turned on according to the programs 3101 stored on the computer readable medium 310. Audio signals may be transmitted from the one or more optional microphones to the at least one router and/or the local computer, step 450. Video signals may be transmitted from the plurality of cameras to the at least one router and/or the local computer according to a predetermined pattern, step 460. The programs 3101 may be configured to allow an operator of the content delivery network server 130 and/or a manager of the corresponding physical venue to preset the predetermined pattern. Video signals transmitted to the at least one router and/or the local computer may be automatically switched from one camera to another camera according to the predetermined pattern. For instance, broadcasted images of the live event may be automatically switched from images captured by one camera to those captured by another camera with a different sight angle after every fixed period of time, e.g. 30 seconds. In some implementations, the programs 3101 may be configured to allow an operator of the content delivery network server 130 or a manager of the corresponding physical venue to preset the pan angle, the tilt angle, and the zoom ratio of each camera at the corresponding physical venue location of the live event.

The audio signals and the video signals are encoded and transmitted to the content delivery network server 130 by the at least one router 1108 and/or the local computer at the corresponding physical venue location of the live event, step 470. In some implementations, the audio signals and the video signals may be combined and compressed by the at least one router 1108 and/or the local computer. Encoded audio and video signals may be received and decoded by the content delivery network server 130, step 480. In some implementations, if received signals are compressed, the compressed signals are de-compressed by the content delivery network server 130. At the end of the scheduled time period, the plurality of cameras and the one or more optional microphones at the specific physical venue of the live event may be automatically turned off, step 490.

The foregoing description has been presented with reference to specific embodiments for purposes of illustration and explanation. However, the illustrative discussions above are not intended to be exhaustive or to limit the invention to the embodiments described. A person skilled in the art may appreciate that many modifications and variations are possible in view of the present disclosure.

What is claimed is:

1. An automated broadcast system, comprising:
one or more automated broadcast sets, each specific automated broadcast set disposed at a specific physical venue location, wherein the specific physical venue location is configured to host live events, the specific automated broadcast set comprising:
a plurality of cameras pre-positioned at different sight angles within the specific physical venue location, the plurality of cameras configured to automatically capture audio-visual information from the live events according to a particular schedule of the live events; and
at least one local device located within the specific physical venue location, the at least one local device having one or more IP addresses, the at least one local device configured to receive video signals from the plurality of cameras, encode the video signals and transmit encoded video signals over a network; and
one or more content delivery network servers, the one or more content delivery network server having one or more IP addresses, the one or more content delivery network servers coupled to the network and configured to receive and decode the encoded video signals;
wherein the one or more content delivery network servers comprises a CPU and a computer readable medium storing programs that, when executed, cause the one or more content delivery network servers to enable server operator(s) and/or venue manager(s) to preset the particular schedule of the live events, receive requests from a plurality of network users for substantially real-time access to the live events, and broadcast user-selected live events to the corresponding network users upon authorized payments or subscriptions.

2. The system as recited in claim 1, wherein one of the plurality of cameras at the specific physical venue location is pre-positioned to provide a wide shot of the entire stage of the corresponding venue location.

3. The system as recited in claim 2, wherein the programs, when executed, cause the one or more content delivery network servers to enable the server operator(s) and/or the venue manager(s) to preset a particular pattern to broadcast a specific live event at the specific physical venue location.

4. The system as recited in claim 3, wherein, according to the particular pattern, captured videos, transmitted to the at least one local device, are switched between cameras after a predefined period of time, whereby only one camera transmits captured videos to the at least one local device at any given time during the specific live event.

5. The system as recited in claim 4, wherein the programs, when executed, cause the one or more content delivery network servers to enable the server operator(s) and/or the venue manager(s) to preset the pan angle, the tilt angle, and the zoom ratio of a specific camera at the specific physical venue location.

6. The system as recited in claim 5, wherein the programs, when executed, cause the one or more content delivery network servers to enable a specific customer to set up a personal account on the one or more content delivery network servers, and track, modify and/or cancel a prior order by logging into the personal account.

7. The system as recited in claim 6, wherein the programs, when executed, cause the one or more content delivery network servers to provide a user menu on the servers; and wherein the user menu includes available live events at the plurality of physical venue locations, the user menu configured to allow a specific customer to place an order of user-selected live events and to cancel or modify the order by entering the order number.

8. The system as recited in claim 6, wherein the programs, when executed, cause the one or more content delivery network servers to convert captured videos of the specific live event into recordings and enable an interested customer to purchase one or more copies of the recordings by paying a fee.

9. The system as recited in claim 1, wherein the specific automated broadcast set comprises one or more optional microphones, pre-positioned within the specific physical venue location; the one or more local devices configured to receive audio signals from the one or more optional microphones, encode the audio signals and transmit encoded audio signals over the network; and wherein the one or more content delivery network servers is configured to receive and decode the encoded audio signals.

10. The system as recited in claim 9, wherein one of the one or more optional microphones within the specific physical venue location is pre-positioned to capture audio of audience at the specific physical venue location.

11. A method of automatically broadcasting live events on a network, comprising:
providing a specific automated broadcast set at each of two or more physical venue locations;
wherein the two or more physical venue locations are configured to host the live events; and
wherein the specific automated broadcast set at a specific physical venue location comprises:
a plurality of cameras pre-positioned at different sight angles within the specific physical venue location, the plurality of cameras configured to automatically capture audio-visual information from the live events according to a particular schedule of the live events; and
one or more local devices located within the specific physical venue location, the one or more local device having one or more IP addresses, the one or more local devices configured to receive video signals from the plurality of cameras, encode the video signals and transmit encoded video signals over the network;
automatically recording the live events at the two or more physical venue locations according to the particular schedule, wherein the particular schedule is preset by server operator(s) or venue manager(s);
transmitting video signals from the plurality of cameras to the one or more local devices according to a particular pattern;
encoding the video signals for transmission over the network;
transmitting encoded video signals over the network;
receiving and decoding the encoded video signals via one or more content delivery network servers;
receiving requests from a plurality of network users for access the live events; and
granting a specific network user access to selected live events upon authorized payments or subscriptions.

12. The method as recited in claim 11, wherein one of the plurality of cameras at the specific physical venue location is pre-positioned to provide a wide shot of the entire stage of the corresponding venue location.

13. The method as recited in claim 11, further comprising: enabling the server operator(s) and/or the venue manager(s) to preset the particular pattern to broadcast a specific live event at the specific physical venue location.

14. The method as recited in claim 13, wherein, according to the particular pattern, captured videos, transmitted to the one or more local devices, are switched between cameras after a predefined period of time, whereby only one camera transmits captured videos the one or more local devices at any given time during the specific live event.

15. The method as recited in claim 14, further comprising: enabling the server operator(s) and/or the venue manager(s) to preset the pan angle, the tilt angle, and the zoom ratio of a specific camera at the specific physical venue location.

16. The method as recited in claim 15, further comprising: enabling a specific customer to set up a personal account on the one or more content delivery network servers, and track, modify and/or cancel a prior order by logging into the personal account.

17. The method as recited in claim 16, further comprising: providing a user menu on the servers; and wherein the user menu includes available live events at the plurality of physical venue locations, the user menu configured to allow a specific customer to place an order of user-selected live events and to cancel or modify the order by entering the order number.

18. The system as recited in claim 16, further comprising: converting captured videos of the specific live event into recordings; and enabling an interested customer to purchase one or more copies of the recordings by paying a fee.

19. The system as recited in claim 11, wherein the specific automated broadcast set comprises one or more optional microphones, pre-positioned within the specific physical venue location; the one or more local devices configured to receive audio signals from the one or more optional microphones, encode the audio signals and transmit encoded audio signals over the network; and wherein the one or more content delivery network servers is configured to receive and decode the encoded audio signals.

20. The system as recited in claim 19, wherein one of the one or more optional microphones within the specific physical venue location is pre-positioned to capture audio of audience at the specific physical venue location.

21. A method of automatically broadcasting live events on a network, comprising:
providing a plurality of cameras at a specific location of two or more physical venue locations; the plurality of cameras configured to automatically capture audio-visual information from the live events according to a particular schedule of the live events;
wherein the plurality of cameras are pre-positioned at different sight angles at the specific venue location; and
wherein the specific venue location has one or more local devices, the one or more local devices having one or more IP addresses, the one or more local devices configured to receive video signals from the plurality of cameras, encode the video signals and transmit encoded video signals over the network;
turning on the plurality of cameras located at the specific venue location at the beginning of a specific live event according to a particular schedule of the live events;
transmitting video signals from the plurality of cameras to the one or more local devices according to a predetermined pattern;
encoding the video signals for transmission over the network;
transmitting encoded video signals over the network;
receiving and decoding the encoded video signals via one or more content delivery network servers,
providing options for server operator(s) and/or venue manager(s) to preset the particular schedule and the predetermined pattern; and
turning off the plurality of cameras located at the specific venue location at the end of the specific event.

22. The method as recited in claim 21, further comprising:
turning on one or more optional microphones located at the specific venue location at the beginning of the specific live event; wherein the one or more optional microphones is pre-positioned at the specific venue location;
transmitting audio signals from the one or more optional microphones to the one or more local devices, the one or more local devices configured to receive audio signals from the one or more optional microphones, encode the audio signals and transmit encoded audio signals over the network;
encoding the audio signals for transmission over the network;
transmitting encoded audio signals over the network;
receiving and decoding the encoded audio signals via the one or more content delivery network servers; and
turning off the one or more optional microphones at the end of the specific live event.

23. The method as recited in claim 22, wherein the one or more optional microphones at the specific venue location is pre-positioned to capture audio of audience at the specific venue location.
